(19) United States
(12) Patent Application Publication
(10) Pub. No.: US 2021/0131560 A1
(43) Pub. Date: May 6, 2021

(54) SEAL RING AND VALVE DEVICE USING THE SAME

(71) Applicant: DENSO CORPORATION, Kariya-city (JP)

(72) Inventor: Noriyuki INAGAKI, Kariya-city (JP)

(21) Appl. No.: 17/148,820

(22) Filed: Jan. 14, 2021

Related U.S. Application Data
(63) Continuation of application No. PCT/JP2019/018940, filed on May 13, 2019.

(30) Foreign Application Priority Data
Jul. 18, 2018 (JP) 2018-134704

(51) Int. Cl. F16J 15/3212; F16J 15/18; F16K 1/226

(52) U.S. Cl. CPC F16J 15/3212; F16K 1/226; F16J 15/18

(57) ABSTRACT

A seal ring used for a valve device may be disposed on an outer peripheral edge of a valve body accommodated in a passage to open or close the passage by rotation. The seal ring includes a resinous ring having a seal surface, a groove provided along a circumferential direction of the resinous ring on one side surface of the resinous ring, and a ring-shaped spring made of a metal and arranged in the groove. A through hole is provided to extend along a central axial direction of the resinous ring from the other side surface opposite to the one side surface toward the one side surface and to penetrate the groove, in a part of an inner peripheral side from a region serving as the seal surface. Furthermore, a locking portion is configured to lock an end portion of the spring arranged in the groove, in a region of the one side surface corresponding to the through hole.

### CROSS REFERENCE TO RELATED APPLICATION

The present application is a continuation application of International Patent Application No. PCT/JP2019/018940 filed on May 13, 2019, which designated the U.S. and claims the benefit of priority from Japanese Patent Application No. 2018-134704 filed on Jul. 18, 2018. The entire disclosures of all of the above applications are incorporated herein by reference.

### TECHNICAL FIELD

The present disclosure relates to a seal ring of a valve device for opening and closing a passage through which a fluid flows.

### BACKGROUND

Conventionally, certain valve devices are known to open and close a passage through which a fluid flows by rotating a valve body housed in the passage. For example, a valve device includes a seal structure which seals a gap between the outer peripheral edge of the valve body and the inner periphery of a passage, when a valve body is fully closed. The seal structure is achieved by a resinous seal ring being fitted in a groove (hereinafter also referred to as “peripheral groove”) provided along an outer peripheral surface of an outer peripheral edge of the valve body.

### SUMMARY

According to an aspect of the present disclosure, a seal ring is used in a valve device for opening and closing a passage through which a fluid flows, and is arranged on an outer peripheral edge of a valve body housed in the passage to open and close the passage by rotation. The seal ring includes a resinous ring having a groove provided along a circumferential direction of the resinous ring on one side surface of the resinous ring, and a metal ring-shaped spring arranged in the groove. A through hole is provided to extend along a central axial direction of the resinous ring from the other side surface opposite to the one side surface toward the one side surface and to penetrate the groove, and is provided in a part of an inner peripheral side from a region serving as a seal surface. A locking portion is configured to lock an end portion of the spring arranged in the groove, in a region of the one side surface corresponding to the through hole.

According to this configuration of the seal ring, it is possible to easily realize a seal ring having an increased rigidity, while easily holding the spring by the locking portion and suppressing the spring from falling off.

### BRIEF DESCRIPTION OF THE DRAWINGS

The above and other objects, features and advantages of the present disclosure will become more apparent from the following detailed description made with reference to the accompanying drawings.

FIG. 1 is a schematic sectional view showing a configuration of a valve device of an embodiment.

FIG. 2 is a cross-sectional view of a valve body and a seal ring.

FIG. 3 is a plan view of the seal ring.

FIG. 4 is a back view of the seal ring of FIG. 3.

FIG. 5 is a cross-sectional view of the seal ring taken along the line V-V in FIG. 3.

FIG. 6 is a cross-sectional view of a mold for manufacturing a seal ring.

FIG. 7 is an enlarged cross-sectional view of a locking portion of the seal ring.

FIG. 8 is an enlarged cross-sectional view showing another embodiment of a locking portion of the seal ring.

FIG. 9 is a plan view of a seal ring according to another embodiment.

FIG. 10 is a back view of the seal ring of FIG. 9.

FIG. 11 is a plan view of a seal ring according to another embodiment.

FIG. 12 is a back view of the seal ring of FIG. 11.

FIG. 13 is a cross-sectional view of a seal ring of another embodiment.

### DESCRIPTION OF EMBODIMENTS

In a valve device, when a valve body is opened from a fully closed state, a seal ring fitted in a peripheral groove is expanded in an outer peripheral direction due to the pressure of gas flowing into the peripheral groove, and the seal ring is expanded in an outer peripheral direction. In this case, the seal ring may easily drop from the peripheral groove. In particular, since the resinous seal ring has low rigidity at a high temperature, it is easily deformed by the pressure of the high-temperature gas flowing through the passage, and the possibility of falling off becomes further higher than that of a metal seal ring.

Here, when focusing on ensuring the rigidity of the seal ring, a metal ring (also referred to as a “spring”) may be used to reinforce the rigidity. In this case, a groove may be provided on the side surface of a seal ring and a metal ring may be assembled to the groove to form a reinforced seal ring, or a ring may be integrally molded by insert molding or the like.

In a seal ring in which a spring is assembled in a groove, the spring may easily fall out from the seal ring in the process of assembling the seal ring into the valve body due to a groove structure. If a locking structure such as an undercut shape is used as the groove structure, it is possible to suppress the dropout. However, in the case of a seal ring having an undercut structure, when the seal ring is released from a mold die used for molding, the seal ring may be deformed, which may lead to deterioration of the seal performance.

In the case where a seal ring is integrally molded with a metal spring, the stress may be generated by the difference in linear expansion between the inner metal spring and the outer resinous seal ring, or by the expansion and contraction of the seal ring in accordance with the opening and closing of the valve body of the valve device. As a result, damages such as damage to the seal ring or damage to the valve device may be caused and the durability may become insufficient.

According to an aspect of the present disclosure, a seal ring includes a resinous ring having a groove provided along a circumferential direction of the resinous ring on one side surface of the resinous ring, and a metal ring-shaped spring arranged in the groove. A through hole is provided to extend along a central axial direction of the resinous ring from the other side surface opposite to the one side surface toward the one side surface and to penetrate the groove, and is provided in a part of an inner peripheral side from a region serving as a seal surface. A locking portion is configured to lock an end portion of the spring arranged in the groove, in a region of the one side surface corresponding to the through hole.

According to this configuration of the seal ring, it is possible to easily realize a seal ring having an increased rigidity, while easily holding the spring by the locking portion and suppressing the spring from falling off. Further, a mold for forming the resinous ring can be realized by a simple mold division, and a deformation of the seal ring that may occur when the seal ring is released can be effectively suppressed. In addition, it is possible to improve durability as compared with an integrally molded seal ring.

Hereinafter, detail embodiments of the present disclosure will be described with reference to the drawings.

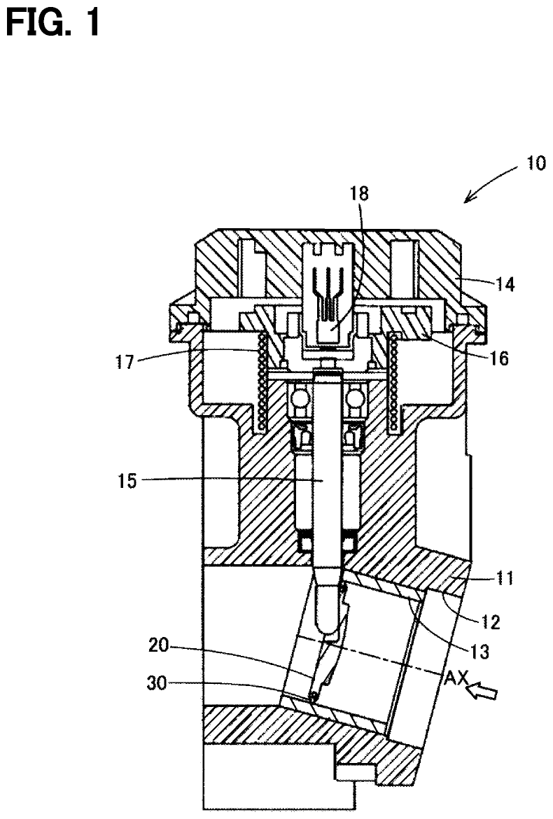

A valve device 10 of an embodiment shown in FIG. 1 opens and closes a passage 12 through which a gas flows, by rotational displacement of a valve body 20. The valve device 10 may be, for example, incorporated in an exhaust system of an engine (not shown), and may be applied to an EGR (exhaust gas recirculation) device that controls the amount of exhaust gas (hereinafter also referred to as EGR gas) recirculated to the engine. That is, the valve device 10 returns EGR gas from an exhaust passage of the engine mounted in the vehicle to an intake passage of the engine, and has a configuration as shown in FIG. 1.

The valve device 10 includes a housing 11, a sensor case 14, and the like.

The housing 11 is made of metal, for example, an aluminum alloy die-cast, and includes a passage 12 through which EGR gas flows from the exhaust passage of the engine to the intake passage of the engine. On the inner wall of the passage 12, a nozzle 13 is fixed. The nozzle 13 is formed of a material having excellent heat resistance and corrosion resistance, for example, stainless steel. That is, the inner periphery of the nozzle 13 is a part of the inner wall of the passage 12 and constitutes a part of the passage 12. The housing 11 rotatably supports the valve body 20 that adjusts the opening degree of the passage 12, and houses a motor that rotates the valve body 20. The motor is not shown because of the arrangement position.

The valve body 20 is a disc-shaped butterfly valve that is rotatably supported within the nozzle 13 via a shaft 15. The valve body 20 is configured to change the opening area of the nozzle 13 in the passage 12 according to a rotational displacement of the shaft 15. That is, the valve body 20 adjusts the opening degree of the nozzle 13 in the passage 12 by rotating integrally with the shaft 15. The valve body 20 may be formed using various metals, such as an aluminum alloy and SUS, and various resins, such as PPS, PTFE, and PEEK.

In addition, the valve body 20 rotates with a rotational torque which is transmitted after being amplified by decelerating the rotation of the motor using a combination of a plurality of gears. Specifically, the rotation of the motor is decelerated using the combination of a motor gear (not shown) that rotates integrally with the motor, an intermediate gear (not shown) that is rotationally driven by this motor gear, and a final gear 16 that is rotationally driven by this intermediate gear. Further, the shaft 15 rotates integrally with the final gear 16.

The valve device 10 is provided with a return spring 17 that biases the valve body 20 only in the valve closing direction. The return spring 17 is a single spring made of a coil spring wound only in one direction, and is coaxially disposed around the shaft 15. The return spring 17 is assembled between the housing 11 and the final gear 16 to generate a spring force that biases in the valve closing direction. In other words, the final gear 16 and the like are rotated against the spring force of the return spring 17.

The sensor case 14 is made of resin and houses a sensor 18 that detects the rotation angle of the valve body 20. The sensor 18 is a contactless position sensor that detects the opening degree of the valve body 20 by detecting the rotation angle of the shaft 15. Further, the housing 11 and the sensor case 14 are integrated by fastening the flange of the housing 11 and the flange of the sensor case 14, which are in contact with each other, with screws.

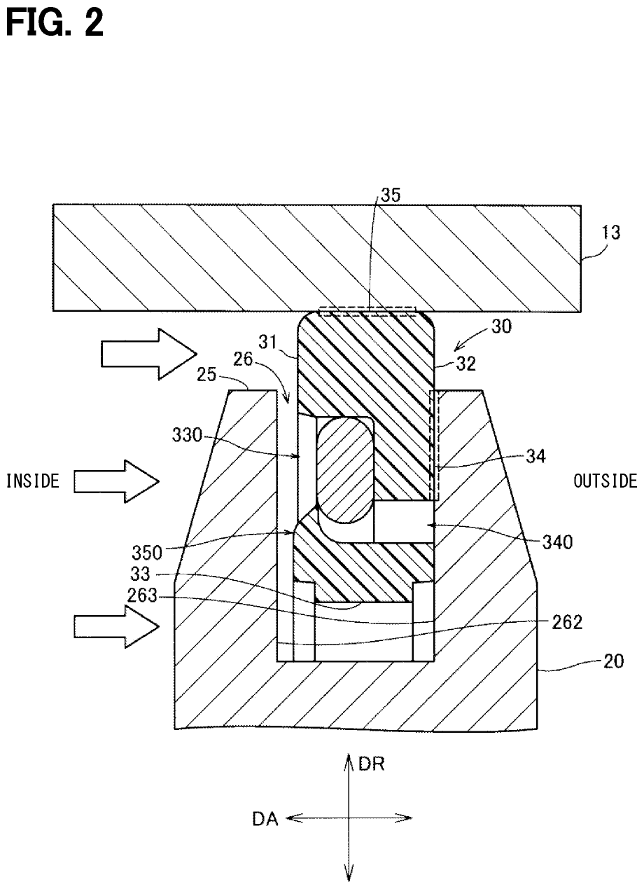

As shown in FIG. 2, a groove 26 having a rectangular cross section (hereinafter, also referred to as “peripheral groove 26”) is provided at the surface (also referred to as “outer peripheral surface”) of the outer peripheral edge 25 of the valve body 20 over the entire circumference. A seal ring 30 is fitted in the peripheral groove 26. The seal ring 30 is configured to seal a gap between an inner peripheral surface of the nozzle 13 and the outer peripheral surface of the outer peripheral edge 25 of the valve body 20 when the valve body 20 is fully closed. More specifically, the outer peripheral edge 35 of the seal ring 30 is positioned outside of the peripheral groove 26, and the inner peripheral edge 33 of the seal ring 30 is fitted inside the peripheral groove 26 and is housed in the peripheral groove 26.

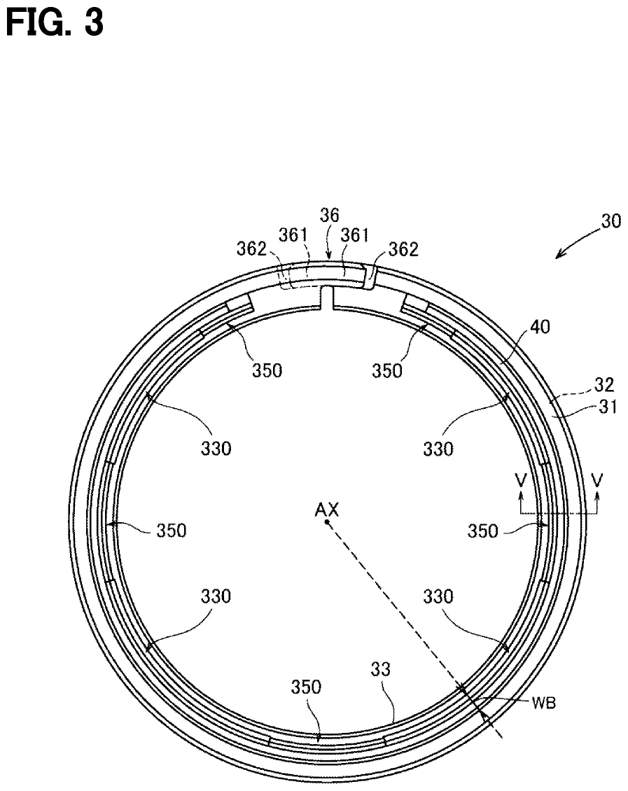

The seal ring 30 has a flat-plate ring shape as shown in the top view of FIG. 3. The seal ring 30 is formed using a resin, such as PPS, PTFE, or PEEK, for example.

FIG. 3 shows a state in which the seal ring 30 is viewed from the upstream side (inside in FIG. 2) of the nozzle 13. Further, FIG. 2 shows the seal ring 30 in the V-V cross section of FIG. 3, with the portion on a side of the outer peripheral edge 25 of the valve body 20. Further, in FIG. 2, the left side corresponds to the upstream side (denoted as “INSIDE”) of the nozzle 13, and the right side corresponds to the downstream side (denoted as “OUTSIDE”) of the nozzle 13. The arrow DR in FIG. 2 indicates a direction along the diameter of the valve body 20 and the seal ring 30 (hereinafter, also referred to as “radial direction”) in the cross section, and the arrow DA indicates a direction along the central axis AX (hereinafter, also referred to as “central axis direction”). The same applies to the following figures.

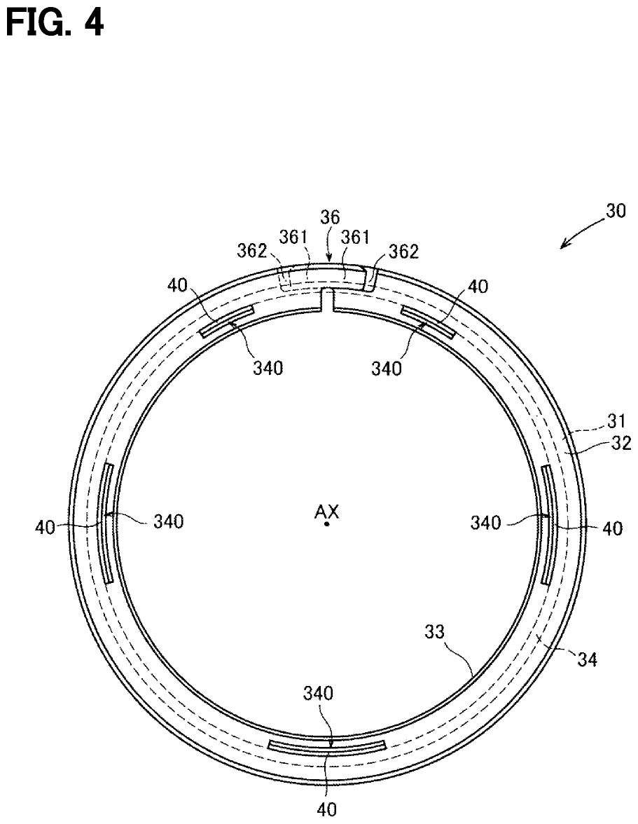

As shown in the plan view of FIG. 3 and the back view of FIG. 4, the seal ring 30 is provided with a joint (abutment) 36 whose diameter can be expanded or contracted. The seal ring 30 can be fitted into the peripheral groove 26 by separating the joint 36, temporarily expanding the diameter of the seal ring 30, arranging the seal ring 30 in the peripheral groove 26, and then reducing the diameter of the seal ring 30 therein.

As shown in FIGS. 3 and 4, a projecting piece 361 projecting from one seal ring end toward the other seal ring end, and a space 362 for receiving the projecting piece 361 are respectively provided at the two ends of the seal ring 30. As a result, the seal ring 30 becomes in an overlapped state at the joint 36 overlapped in the radial direction and the central axis direction of the seal ring 30 as shown in FIG. 3, when the seal ring 30 is fitted in the peripheral groove 26 and when the valve body 20 is fully closed. The shape of the joint 36 is an example, but is not limited to this shape and the state as long as it has a configuration in which the overlapped part occurs in the radial direction and the central axis direction.

When the valve body 20 is fully closed, as shown in FIG. 2, the seal ring 30 is pushed to the downstream side by the differential pressure generated on the upstream side and the downstream side of the seal ring 30, and a part 34 of the side surface 32 facing the downstream side comes into close contact with the side surface 263 on the downstream side of the peripheral groove 26. (Hereinafter, the part 34 is referred to as “seal surface 34”.) As a result, the flow of gas passing through a side of the inner peripheral edge 33 of the seal ring 30 is blocked, and the pressure on the inner peripheral edge 33 rises. Further, since the gas flows through the gap (not shown in FIG. 2) on the side of the outer peripheral edge 35 of the seal ring 30, the pressure on the side of the outer peripheral edge 35 of the seal ring 30 becomes low. Therefore, the diameter of the seal ring 30 is increased by the differential pressure generated between the inner peripheral edge 33 and the outer peripheral edge 35, and the outer peripheral surface of the outer peripheral edge 35 of the seal ring 30 comes in close contact with the inner peripheral surface of the nozzle 13. The outer peripheral edge 35 of the seal ring 30 is also referred to as a sealing surface 35. As a result, when the valve body 20 is fully closed, the seal surface 34 of the side surface 32 of the seal ring 30 tightly contacts the side surface 263 of the peripheral groove 26 of the valve body 20, and the seal surface 35 of the seal ring 30 tightly contacts the inner peripheral surface of the nozzle 13. With this, the seal ring 30 tightly seals the gap between the valve body 20 and the nozzle 13. Although the joint 36 is separated by expanding the diameter, the overlapping portions of the joint 36 are brought into close contact with each other due to the differential pressure generated in the radial direction and the central axial direction when the valve body 20 is fully closed. This prevents gas from leaking from the upstream side to the downstream side through the joint 36.

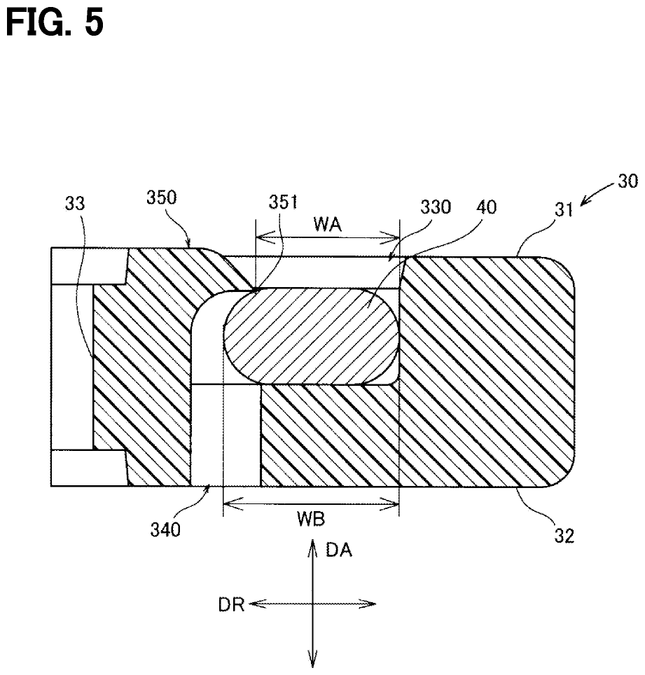

As shown in the plan view of FIG. 3 and the cross-sectional view of FIG. 5, a plurality of grooves 330 arranged along the circumferential direction are provided on the side surface 31 at the upstream side of the seal ring 30. The grooves 330 are provided at an outer side in the circumferential direction, in areas except for the region of the joint 36 A ring-shaped spring 40 made of a metal material is disposed in the groove 330. The metal material of the spring 40 is not particularly limited as long as the rigidity of the seal ring 30 made of resin can be maintained at a predetermined value or higher, and various metals such as aluminum alloy and SUS can be used. Hereinafter, the groove 330 is also referred to as a “spring groove 330”. In the following description, the upstream side surface 31 is also referred to as “one side surface 31”, and the downstream side surface 32 is also referred to as “opposite side surface 32”.

As shown in the back view of FIG. 4 and the cross-sectional view of FIG. 5, on the downstream side surface 32 (i.e., opposite side surface), a plurality of holes 340 are provided along the circumferential direction, in a resign on an inner peripheral side of the radial direction DR from the region serving as the seal surface 34. The hole 340 is provided so as to extend from the downstream side surface 32 toward the upstream side surface 31 of the seal ring 30 along the central axial direction DA and penetrate through the bottom surface of the end portion on the inner peripheral side of the spring groove 330. Hereinafter, the hole 340 is also referred to as a “through hole 340”.

In the plan view seen from the one side surface 31, the spring groove 330 is arranged in the region of the one side surface 31 corresponding to the through hole 340. A hook-shaped locking portion 350 is provided to cover and lock an end on the inner peripheral side of the spring 40 provided in the spring groove 330, as shown in the plan view of FIG. 3 and the cross-sectional view of FIG. 5. In the cross section of the seal ring 30 in the region having the locking portion 350, the open dimension WA of the spring groove 330 is smaller than the width dimension WB of the spring 40 in the radial direction DR. The open dimension WA of the spring groove 330 is a difference between positions of a tip 351 of the locking portion 350 and the outer peripheral end of the spring groove 330 in the radial direction DR. Further, as shown in FIG. 3, the radial width WB of the spring 40 is the difference between an inner peripheral end and the outer peripheral end of the spring 40, that is, the difference between the inner diameter and the outer diameter of the spring 40, in the radial direction DR.

The seal ring 30 is configured to have the structure of the spring groove 330, the through hole 340, and the locking portion 350 described above, so that the spring 40 can be locked and prevented from being falling. The seal ring 30 can secure a desired rigidity by the locked spring 40. Further, as shown in FIG. 5, because the width which is the difference between the inner peripheral surface and the outer peripheral surface of the groove 330 is formed wider than the width WA of the spring 40, it is possible to suppress the stress generated by the difference of the linear expansion between the spring 40 and the seal ring 30 and the stress caused by the expansion and contraction of the seal ring 30. As a result, it is possible to improve the durability as compared with the durability generated by the seal ring in which the spring is integrally molded.

Further, the seal ring 30 has the locking portions 350 at a plurality of locations along the circumferential direction. As a result, the spring 40 can be easily accommodated in the spring groove 330 in a plurality of regions without having the locking portion 350, and the spring 40 can be suppressed from falling off by the plurality of locking portions 350. That is, it is possible to achieve both the ease of assembling the spring ring 40 and the suppression of the spring 40 from falling off. Further, since the plurality of locking portions 350 are provided at the plural positions along the circumferential direction, it is possible to prevent the spring 40 from falling off in a well-balanced manner along the circumferential direction.

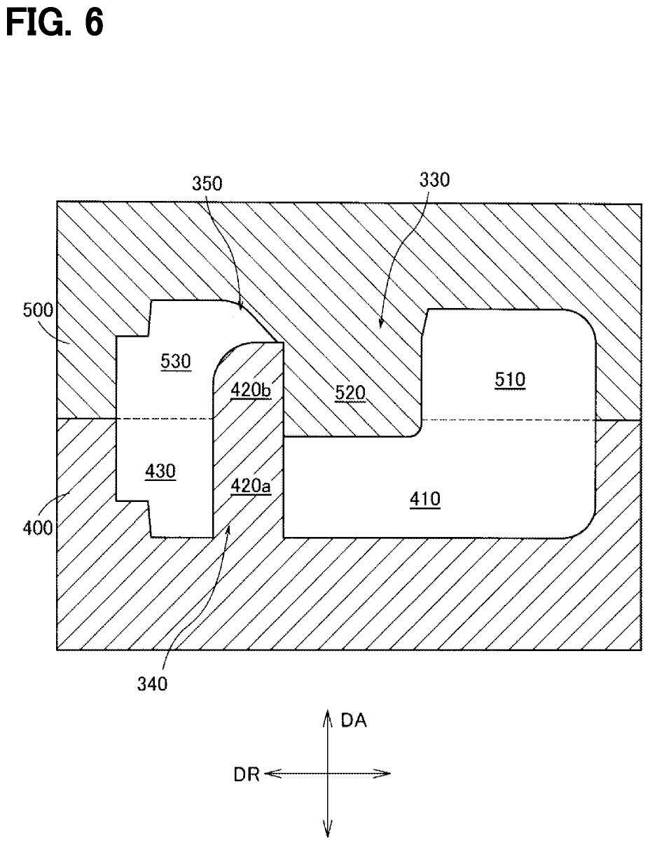

As shown in the cross-sectional view of FIG. 6, the seal ring 30 can be formed by using a lower mold 400 and an upper mold 500 of a simple mold split. The seal ring 30 is formed by filling and solidifying a resin material in a mold made of a lower mold 400 having cavities 410, 430 and cores 420a, 420b and an upper mold 500 having cavities 510, 530 and core 520. The core 520 facing the lower die 400 in the central axial direction DA of the upper die 500 and the core 420b of the cores 420a and 420b facing the upper die 500 in the central axial direction DA of the lower die 400 correspond to the region of the spring groove 330 shown in FIG. 5. Further, the portion of the core 420a corresponds to the region of the through hole 340 shown in FIG. 5.

As described above, the lower mold 400 and the upper mold 500 have a simple mold dividing structure that is uneven along the central axis direction DA. Therefore, it is easy to release the formed seal ring 30 from the mold, and it is possible to suppress a decrease in the seal performance, which is caused by a deformation of the seal ring due to a poor mold release property as in the undercut structure described in the prior art.

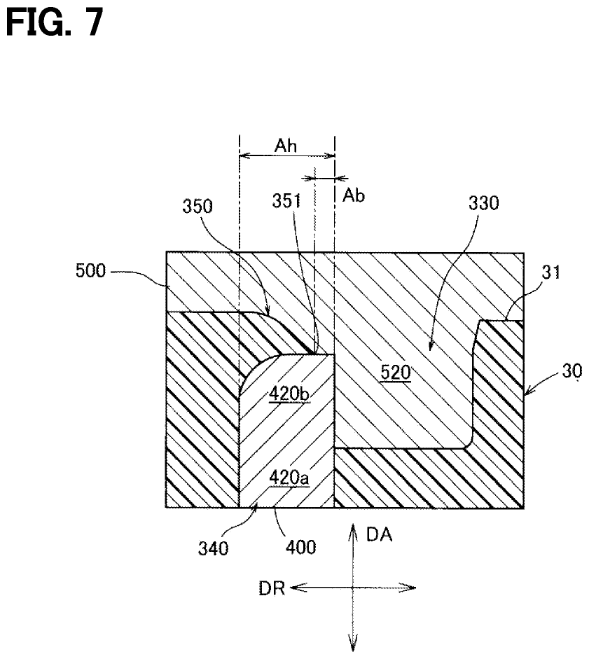

As shown in the cross-sectional view of FIG. 7, the hook tip 351 of the locking portion 350 is preferably located within the resign of a width Ah between an inner peripheral end portion and an outer peripheral end portion of the through hole 340, as in a plan view from the one side surface 31. In this case, since the core 420b connected to the core 420a of the lower mold 400 corresponding to the through hole 340 provides a cut-out region Ab with the hook tip 351 of the locking portion 350 formed, it can effectively suppress burrs during resin molding. However, the present disclosure is not limited to this, and the hook tip 351 may coincide with the end of the through hole 340.

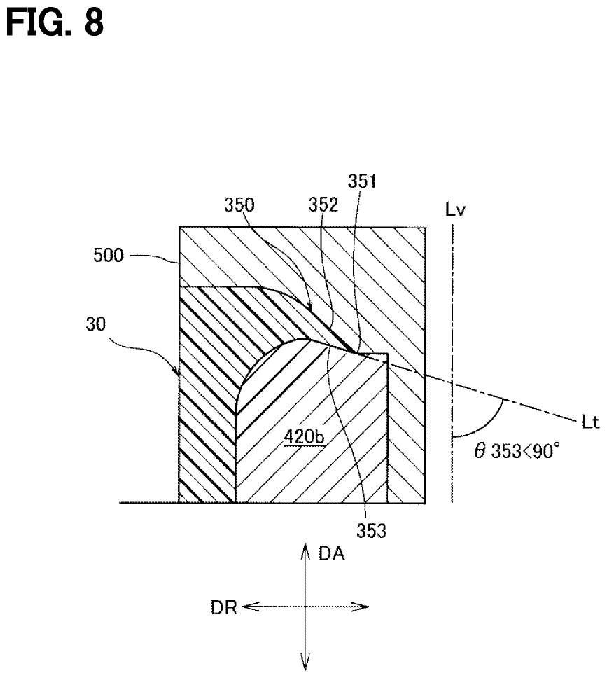

Further, as shown in FIG. 8, a tip angle 8353 of a tip surface 353 of the locking portion 350 on a side of the through hole 340 is an angle with respect to a reference line Lv along the central axial direction DA, which is a direction perpendicular to one side surface 31. It is preferably to form the tip angle 8353 as an acute angle with respect to the reference line Lv, that is, less than 90°. The tip angle 8353 of the tip surface 353 is an angle formed by the tangent line Lt of the tip surface 353 and the reference line Lv on the cross section, and is an angle viewed from the through hole 340 side. In this case, it is possible to improve the locking property of the spring 40 by the locking portion 350 and more effectively suppress the spring 40 from falling off.

Further, as shown in FIG. 8, the tip surface 352 of the locking portion 350 on the side of the one side surface 31 has a tapered surface shape that is substantially linearly recessed toward the tip 351. In this case, when the spring 40 is assembled to the spring groove 330, it is possible to slide the end portion of the spring 40 on the inner peripheral side along the tip surface 352, so to facilitate the assembly of the spring 40 to the spring groove 330. Although not shown, the tip surface 352 may have a curved surface that is convex outward and smooth, rather than linear. Even in this case, the same effect can be obtained.

### OTHER EMBODIMENTS

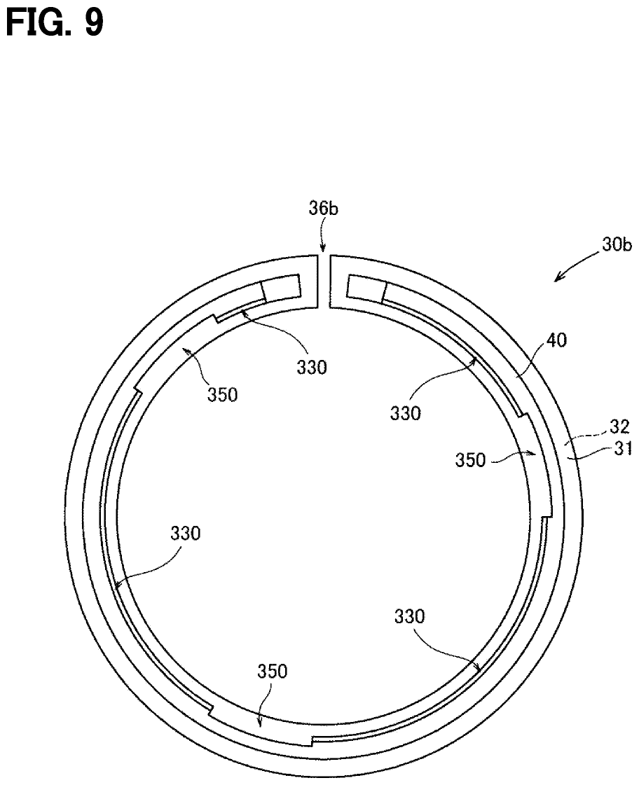

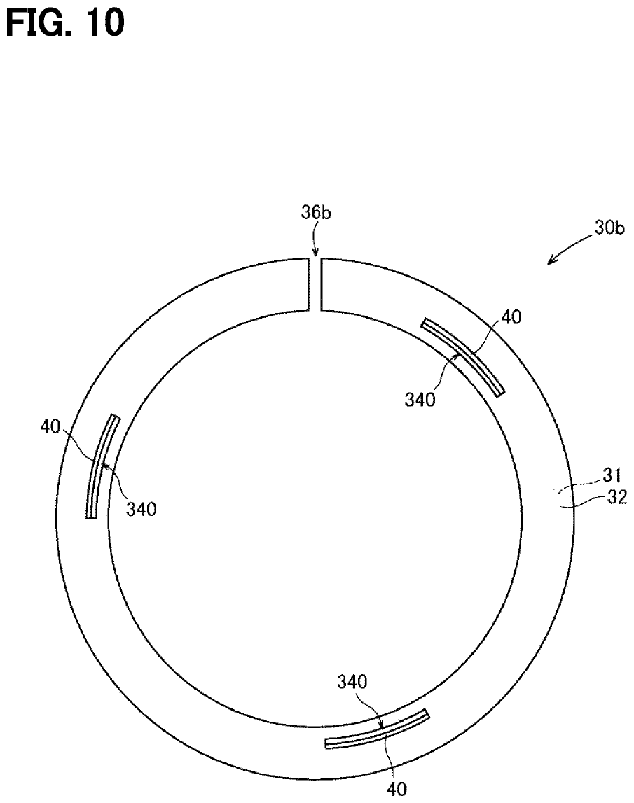

(1) As shown in a seal ring 30b of FIGS. 9 and 10, instead of the joint 36 (FIG. 3), a joint 36b (abutment) without the protruding piece 361 and the space 362 may be used.

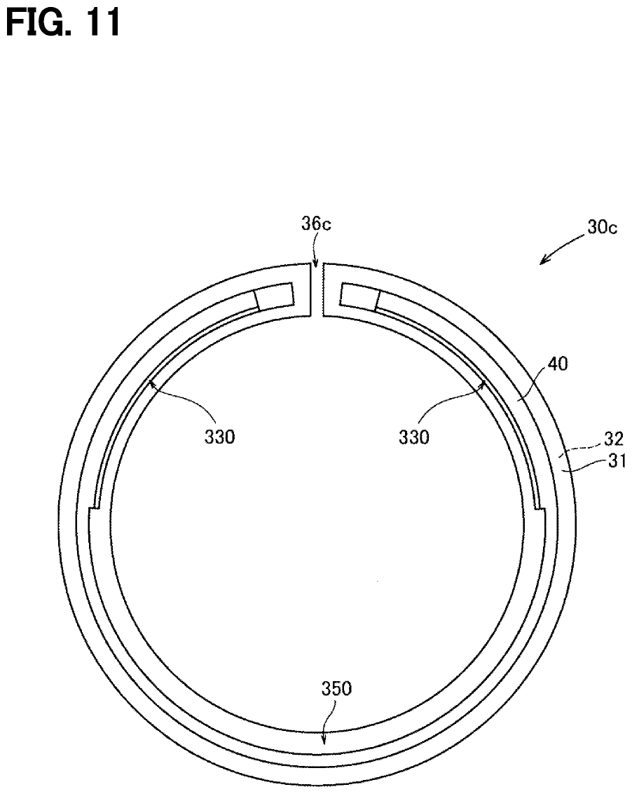

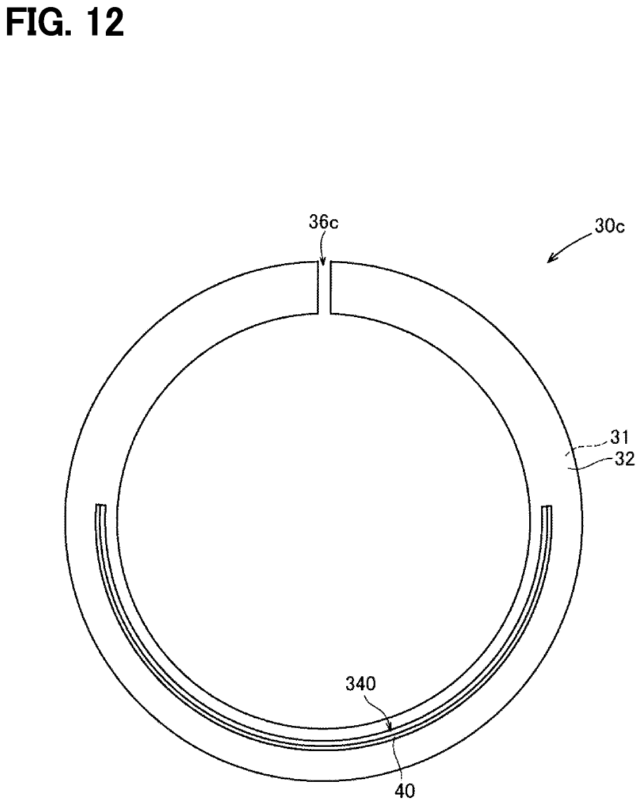

(2) Further, the positions and numbers of the locking portions 350 and the corresponding through holes 340 are not limited to the positions and numbers of the seal rings 30 shown in FIGS. 3 and 4. As shown in the seal rings 30b of FIGS. 9 and 10, the locking portions 350 and the corresponding through holes 340 may be provided evenly at three locations along the circumferential direction. Further, as shown in a seal rings 30c of FIGS. 11 and 12, a single locking portion 350 and a through hole 340 corresponding thereto may be provided. That is, as long as the locking portion 350 and the corresponding through hole 340 are partially provided along the circumferential direction, the position and number of the locking portion 350 and the corresponding through hole 340 are not limited to the above-described examples.

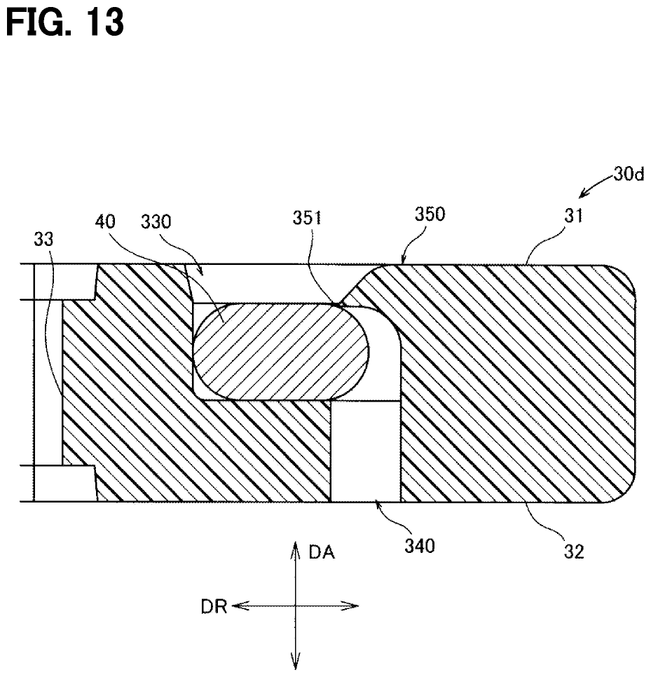

(3) In the above embodiments, for example, as shown in FIG. 5, a configuration in which a locking portion 350 and a corresponding through hole 340 are provided on a side of the inner peripheral end of the spring 40 is taken as an example. However, it is not limited to this. As shown in a seal ring 30d of FIG. 13, the locking portion 350 and the corresponding through hole 340 may be provided on a side of the outer peripheral end of the spring 40.

(4) Although the valve device of the above embodiment has been applied to the EGR device, it can be applied as a valve device that opens and closes passages of various fluids without limiting to the EGR device.

The present disclosure should not be limited to the embodiments described above, and various other embodiments may be implemented without departing from the scope of the present disclosure. For example, the technical features in each embodiment corresponding to the technical features in the form described in the summary may be used to solve some or all of the above-described problems, or to provide one of the above-described effects. In order to achieve a part or all, replacement or combination can be appropriately performed. Also, if the technical features are not described as essential in the present specification, they can be deleted as appropriate.

What is claimed is:

1. A seal ring used for a valve device, the seal ring being disposed on an outer peripheral edge of a valve body accommodated in a passage to open or close the passage by rotation, the seal ring comprising:
a resinous ring having a seal surface;
a groove provided along a circumferential direction of the resinous ring on one side surface of the resinous ring;
a ring-shaped spring made of a metal and arranged in the groove;
a through hole provided to extend along a central axial direction of the resinous ring from the other side surface opposite to the one side surface toward the one side surface and to penetrate the groove, the through hole being provided in a part of an inner peripheral side from a region serving as the seal surface; and
a locking portion configured to lock an end portion of the spring arranged in the groove, in a region of the one side surface corresponding to the through hole.

2. The seal ring according to claim 1, wherein
an open dimension of the groove at the locking portion is smaller than a dimension of the spring in a radial direction of the resinous ring.

3. The seal ring according to claim 1, wherein
the through hole and the locking portion paired with the through hole are provided at a plurality of positions along the circumferential direction of the resinous ring.

4. The seal ring according to claim 1, wherein
a hook tip of the locking portion is located within a region of the through hole in a plan view from a side of the one side surface.

5. The seal ring according to claim 1, wherein
a tip angle of a tip surface of a hook tip of the locking portion is formed at an acute angle with respect to a direction perpendicular to the one side surface.

6. The seal ring according to claim 1, wherein
a tip surface of a hook tip of the locking portion on the side of the one side surface is formed in a curved surface shape being outwardly convex or a tapered surface shape.

7. The seal ring according to claim 1, wherein
the resinous ring is disposed at an outer periphery of the valve body, to seal a gap between the valve body and the passage in a fully closed state of the valve body.

8. A seal ring for a valve device, the seal ring being disposed on an outer peripheral edge of a valve body accommodated in a passage to open or close the passage, the seal ring comprising:
a resinous ring having a seal surface, the resinous ring having a groove along a circumferential direction of the resinous ring on a first side surface of the resinous ring; and
a spring made of a metal and arranged in the groove, wherein
a through hole is provided in the resinous ring to extend along a central axial direction of the resinous ring from a second side surface opposite to the first side surface toward the first side surface and to penetrate the groove, the through hole being provided in a part of an inner peripheral side from a region serving as the seal surface,
a locking portion provided in the resinous ring to lock an end portion of the spring arranged in the groove, in a region of the first side surface corresponding to the through hole, and
the groove has a groove opening opened at the first side surface of the resinous ring, and defined by the resinous ring and the locking portion, and
an open dimension of the groove opening is smaller than a dimension of the spring, in a radial direction of the resinous ring.

9. A valve device for opening or closing the passage through which the fluid flows, comprising:
a valve body housed in the passage through which the fluid flows to open or close the passage by rotation; and
a seal ring according to claim 1, disposed at an outer periphery of the valve body, to seal a gap between the valve body and the passage in a fully closed state of the valve body.
